(19) United States
(12) Patent Application Publication
(10) Pub. No.: US 2013/0227474 A1
(43) Pub. Date: Aug. 29, 2013

(54) CLICLKESS GRAPHICAL USER INTERFACE FOR DISPLAYING AND SELECTING A POP-UP MENU

(71) Applicant: KING FAHD UNIVERSITY OF PETROLEUM AND MINERALS, (US)

(72) Inventors: MEHMET DONDURUR, CROFTON, MD (US); AHMET Z. SAHIN, DHAHRAN (SA)

(73) Assignee: KING FAHD UNIVERSITY OF PETROLEUM AND MINERALS, Dhahran (SA)

(21) Appl. No.: 13/856,422

(22) Filed: Apr. 3, 2013

Related U.S. Application Data
(63) Continuation-in-part of application No. 12/985,165, filed on Jan. 5, 2011.

(51) Int. Cl. G06F 3/0482

(52) U.S. Cl. CPC G06F 3/0482
USPC 715/808

(57) ABSTRACT

The clickless graphical user interface provides a pop-up window when a cursor is moved over designated areas on the screen. The pop-up window includes menu item choices, e.g., “double click”, “single click”, “close” that execute when the cursor is moved over the item. This procedure eliminates the traditional ‘mouse click’, thereby allowing users to move the cursor over the application or file and open it by choosing among the aforementioned choices in the file or application being focused on. The pop-up window shows the navigation choices in the form of a text, e.g., yes/no or color, e.g., red/blue, or character, such as triangle for ‘yes’ and square for ‘no’. Pop-up window indicator types are virtually unlimited and can be changed to any text, color or character. The method is compatible with touch pads and mouse interface devices.

### CROSS-REFERENCE TO RELATED APPLICATION

This application is a continuation-in-part of U.S. patent application Ser. No. 12/985,165, filed Jan. 5, 2011.

### BACKGROUND OF THE INVENTION

1. Field of the Invention

The present invention relates to a graphical user interface (GUI), and more particularly to a clickless graphical user interface (GUI) that eliminates the need for mouse clicks for activation of objects pointed to by a cursor.

2. Description of the Related Art

Many computer operating systems on personal computers, desktops, notebooks, and laptops have a graphical interface that utilizes clickable icons and menus on the computer screen. To input commands to the computer, a user commonly uses a mouse to move a cursor over an object of interest on the screen, and then physically clicks on an appropriate mouse button to activate an icon, button, web page link, drag-down menu, or the like associated with the object of interest pointed to by the cursor. The trend of using mouse-clicks for input appears likely to continue into the future, as it has become ingrained into the way we interact with our computers.

Clicking on a mouse button requires a certain nimbleness in the user's fingers, especially for such operations as double-clicks (in which the user clicks on the mouse button twice in rapid succession), drag-and-drops (in which the user clicks and holds the mouse button, moves the cursor and then releases the mouse button), copy-and-paste (in which the cursor is moved to the beginning of the text, the mouse button held down, and the cursor dragged across the text to be marked), and even triple-clicks (in which the user presses the button three times in quick succession, most commonly seen in word processors and web browsers to select a whole section of text). However, a clumsy user or one who is suffering from arthritis or other ailments of the finger joints may lack the capacity to perform these actions, which may be required to operate the computer properly.

Studies have shown that a user may click the mouse button more than two million times a year. Users are beginning to tire of the same old interfacing methodologies, which strain users' digits. There is a long felt need for a better methodology for using graphical user interfaces.

Thus, a clickless graphical user interface for displaying and selecting a pop-up menu solving the aforementioned problems is desired.

### SUMMARY OF THE INVENTION

The clickless graphical user interface provides a pop-up window when a cursor is moved over designated areas on the screen. The pop-up window includes choices, e.g., “double click”, “single click”, “close” that execute when a mouse is moved over the menu item. This procedure eliminates the traditional ‘mouse click’, thereby allowing users to move the cursor over the application or file and open it by choosing among the aforementioned choices in the file or application being focused on.

The pop-up window shows the navigation choices in the form of a text (yes/no) or color (Red/blue), or character (such as triangle for ‘yes’ and square for ‘no’). Pop-up window indicator types are unlimited and can be changed to any text, color or character. Thus, clickless file navigation is provided. The method is easier to use, faster to navigate, and eliminates the noise of the mouse click. The method is compatible with touch pads and mouse interface devices.

These and other features of the present invention will become readily apparent upon further review of the following specification and drawings.

### BRIEF DESCRIPTION OF THE DRAWINGS

FIG. 1 is a screen shot showing a text-based embodiment of a clickless graphical user interface for displaying and selecting a pop-up menu according to the present invention.

FIG. 2 is a screen shot showing a color-based embodiment of the clickless graphical user interface for displaying and selecting a pop-up menu according to the present invention.

FIG. 3 is a screen shot showing a color-based embodiment of the clickless graphical user interface for displaying and selecting a pop-up menu according to the present invention.

FIG. 4 illustrates a set of graphical options provided to the user for use with a clickless graphical user interface for displaying and selecting a pop-up menu according to the present invention.

FIG. 5 illustrates system components for implementing a clickless graphical user interface for displaying and selecting a pop-up menu.

FIG. 6A and FIG. 6B sequentially illustrate operation of an alternative embodiment of a clickless graphical user interface for displaying and selecting a pop-up menu.

FIG. 7A and FIG. 7B sequentially illustrate operation of another alternative embodiment of a clickless graphical user interface for displaying and selecting a pop-up menu.

FIG. 8 illustrates still another alternative embodiment of a clickless graphical user interface for displaying and selecting a pop-up menu.

FIG. 9 illustrates yet another alternative embodiment of a clickless graphical user interface for displaying and selecting a pop-up menu.

Similar reference characters denote corresponding features consistently throughout the attached drawings.

### DETAILED DESCRIPTION OF THE PREFERRED EMBODIMENTS

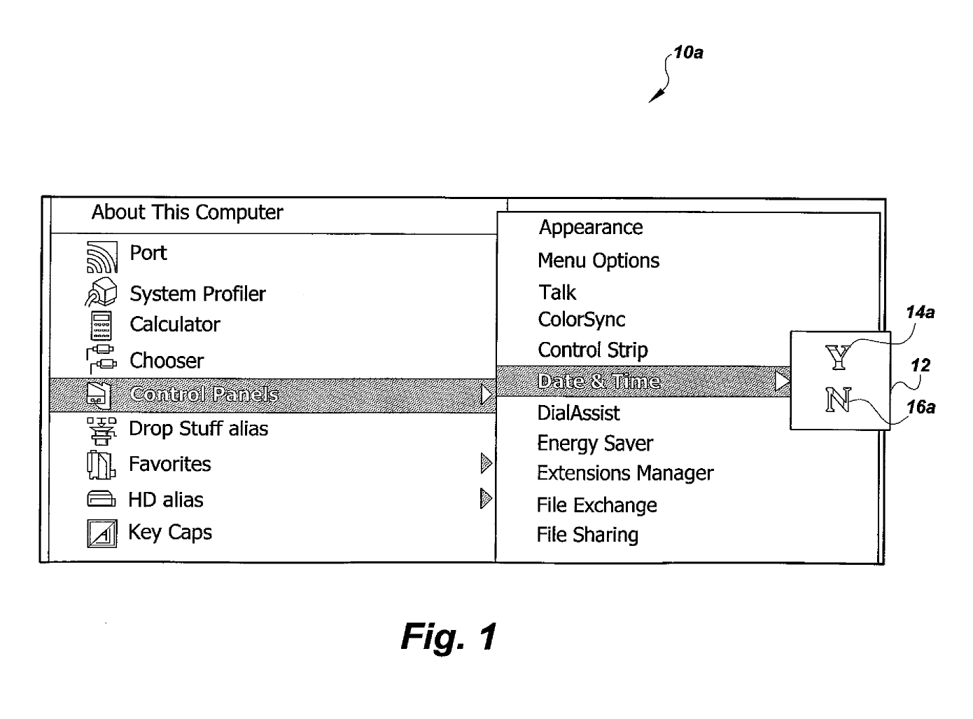

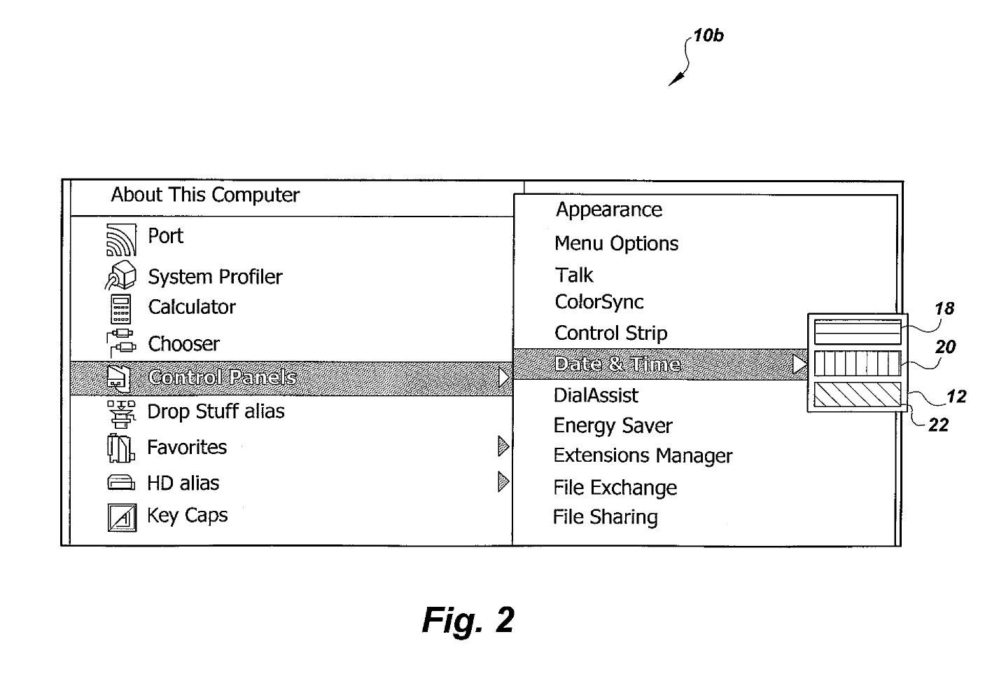

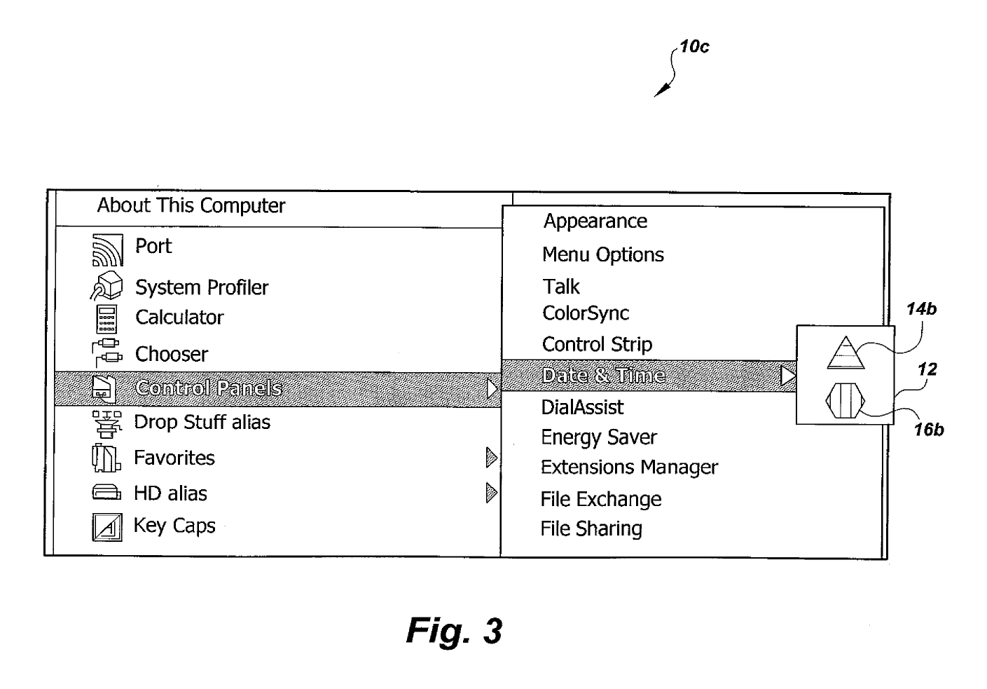

The clickless graphical user interface has been developed in a text-based embodiment of a clickless graphical user interface 10a (shown in FIG. 1), a color-based embodiment of a clickless graphical user interface 10b (shown in FIG. 2), and a shape-based embodiment of a clickless graphical user interface 10c (shown in FIG. 3), which provide a pop-up window or pop-up menu when a cursor is moved over designated areas on the screen (it will be understood that “moved over” means moving the cursor and retaining the cursor in the desired position for a predetermined period of time), e.g., by moving a mouse. The pop-up window 12 includes a choice of menu items, e.g., “double click”, “single click”, “close”, etc., that execute when the cursor is when moved over the item. This procedure eliminates the traditional ‘mouse click,’ thereby allowing users to move the cursor over the application or file and open it by choosing among the aforementioned menu item choices provided for the file or application being focused on.

As shown in FIG. 1, the pop-up window 12 can display the navigation choices in the form of a text (Y 14a for yes/N 16a for no), Y 14a causing the file or application to open, and N 16a causing the file or application to close or go back or cancel an action. Instead of “Y” and “N”, the menu items may be the words “Open”, “Close”, and “Cancel”, or any other descriptive word or phrase suitable to the context. The initial object which the user scrolls over is either an application (e.g., a program or application to be executed) or a file (e.g., a text or graphic file to be opened and displayed). The options then displayed to the user, as described above, are either execution-related computer actions (e.g., open, close, etc.) or a cancellation choice (e.g., no or cancel).

As shown in FIG. 2, the pop-up window 12 can display the navigation choices in the form of colors e.g., red 20, green 22, or blue 18, where blue 18 is used to open an application, file or folder, red 20 is used to close, and green 22 is used to cancel an action.

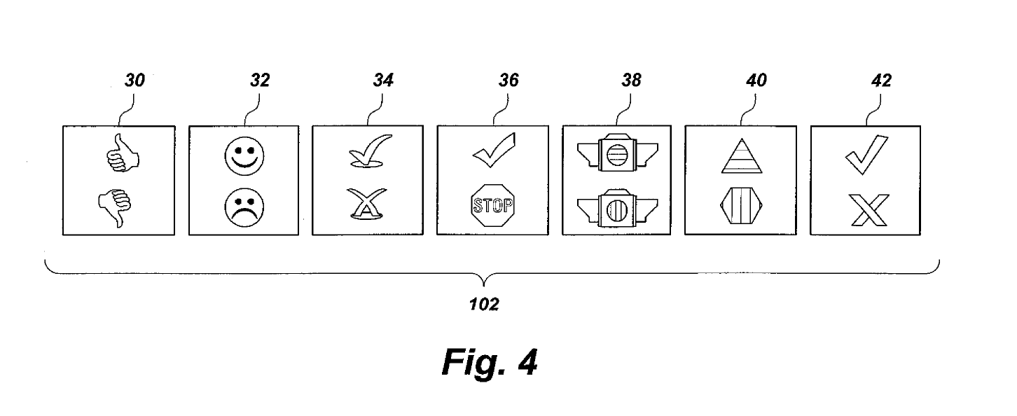

As shown in FIG. 3, the pop-up window 12 can display the navigation choices in the form of iconic indicia distinguished by the shape of the icon or symbol, e.g., triangle 14b for ‘yes’ and hexagon 16b for ‘no’. FIG. 4 illustrates a set 102 of user-selectable options to replace the above-described options of window 12. A variation of the window 12 of FIG. 3 is offered as a selectable choice 40 in set 102 (with the hexagon 16b of FIG. 3 being replaced by an octagon). The user may select any of the desired display options of set 102, such as the thumbs-up and thumbs-down icons of option element 30, the smiling face and frowning face of option element 32, the stylized check mark and “X” of option element 34, the stylized check mark and stop sign of option element 36, the green light and red light of option element 38, the aforementioned option element 40, or the further stylized check mark and “X” of option element 42. It should be understood that the design and iconography of the options is shown for exemplary purposes only, and that any matching pair of icons to represent positive and negative choices may be utilized.

The pop-up window indicator types of 10a, 101), and 10c are virtually unlimited and can be changed to any text, color, character, or visual indicia. Thus, clickless file navigation is provided. The method is easier to use, faster to navigate, and eliminates the noise of a mouse click. The method is compatible with touch pads and mouse interface devices. Thus, navigation style is reflected in the type of text, color or shape used, and the final action choice reflects the functionality to finalize a navigation action initiated by the user positioning of a cursor on an object, item, or visual image displayed on the screen.

To operate or open an item, a user merely moves the mouse or a touch in a touch screen over any item, and this user action causes a hierarchal pop-up window 12 or pop-up menu to display text (Y 14a/N 16a or OPEN/CANCEL, etc.), or a color (R 18, G 20, or B 22) or graphic iconic indicia, e.g. triangle 14b or hexagon 16b to open a file. The user then moves the mouse cursor over a choice, such as OPEN/CANCEL or YIN text or color icon (Red for close, Blue for Open), or shape (small characters or shapes to open and close) to open or cancel the open action for opening file or application. To close an already open file or application, the user moves the cursor over the title bar of the window, which causes a small action window to popup to close or cancel the close action. The clickless graphical user interface can be used for all GUI-based operating systems, such as Mac OSX, WINDOWS®, LINUX®, or the like. Moreover, the clickless method may be used for any software application utilizing a no click concept, including Web tools and applications.

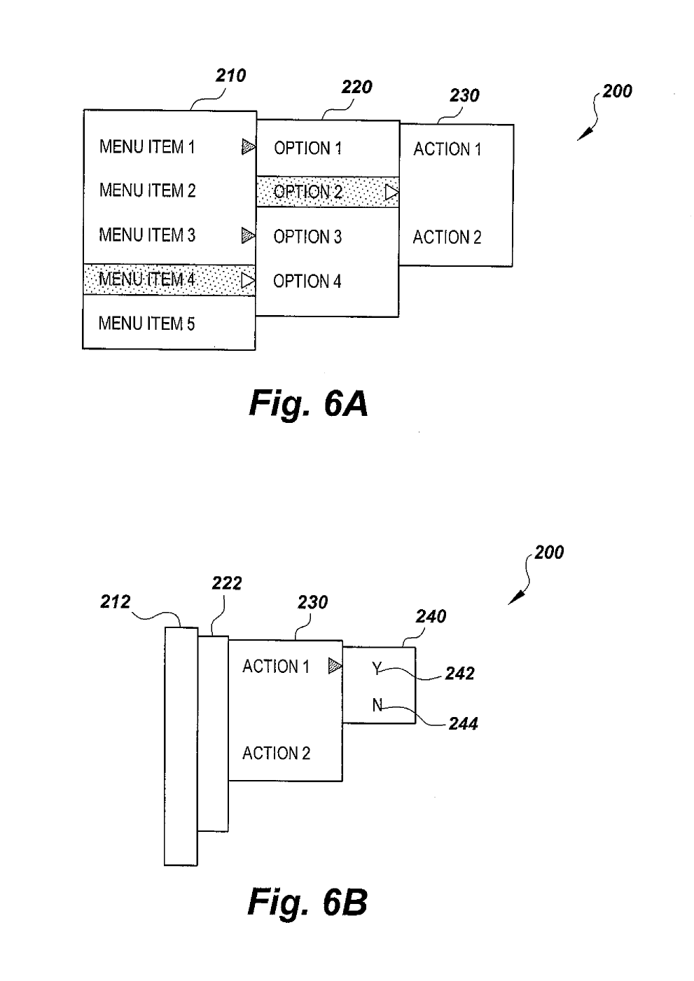

FIGS. 6A and 6B illustrate an alternative embodiment of the clickless graphical user interface for displaying and selecting a pop-up menu 200. As shown in FIGS. 6A and 6B, in interface 200, when multiple menu windows are opened, such as initial menu 210, sub-menu 220 and sub-sub-menu 230, upon the opening of the final window 230, the previous menus are condensed such that they are shown only as smaller, stacked tabs 212, 222, respectively. As shown in FIG. 6B, upon reaching the final menu 230, only the final menu 230 remains full-sized, at which point the option box 12 is presented to the user, as described above with reference to the embodiment of FIG. 1.

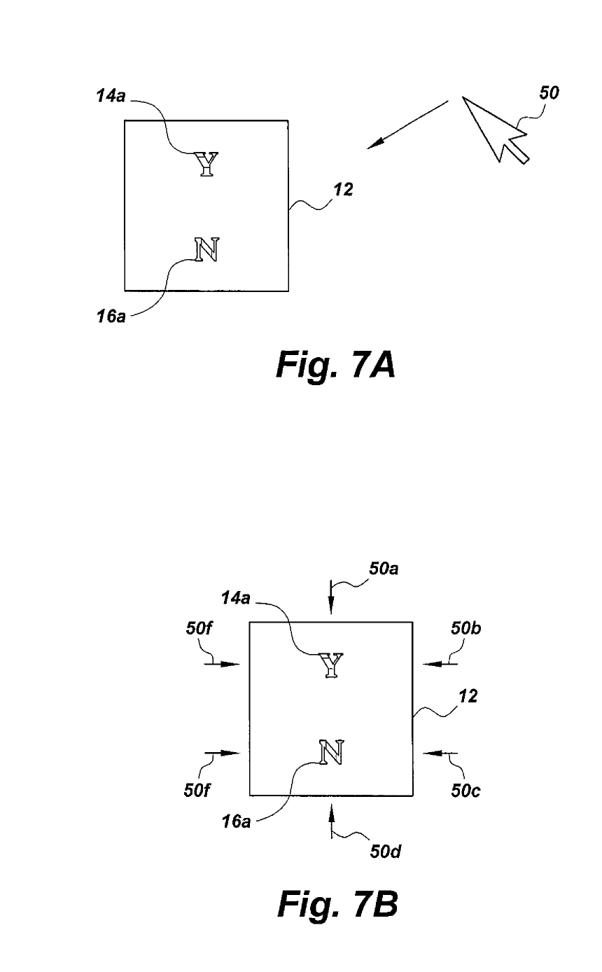

As shown in FIGS. 7A and 7B, as a further alternative, when the conventional cursor 50 is brought near the option box 12, as in FIG. 7A, the original cursor 50 disappears, and is replaced by either a horizontal or vertical arrow graphic, dependent upon the cursor's nearest location. For example, if cursor 50 is brought near box 12 from the right (as in FIG. 7A) near the upper choice (the “yes” option 14a), then cursor 50 will be replaced by the left-facing, upper horizontal arrow graphic 50b. If brought near box 12 from the right but near the lower choice 16a, then cursor 50 would be replaced by the left-facing, lower horizontal arrow graphic 50c. Similarly, if cursor 50 is brought near box 12 from the left, near the upper choice 14a, then cursor 50 will be replaced by the right-facing, upper horizontal arrow graphic 50f, and if brought near box 12 from the left, but near the lower choice 16a, the cursor 50 will be replaced by the right-facing, lower horizontal arrow graphic 50e. If brought from above or below, near the corresponding upper and lower options, the cursor 50 is replaced by vertical arrows 50a, 50d, respectively. The replacement of cursor 50 occurs when the cursor 50 is moved within a pre-defined distance threshold of the pop-up window 12.

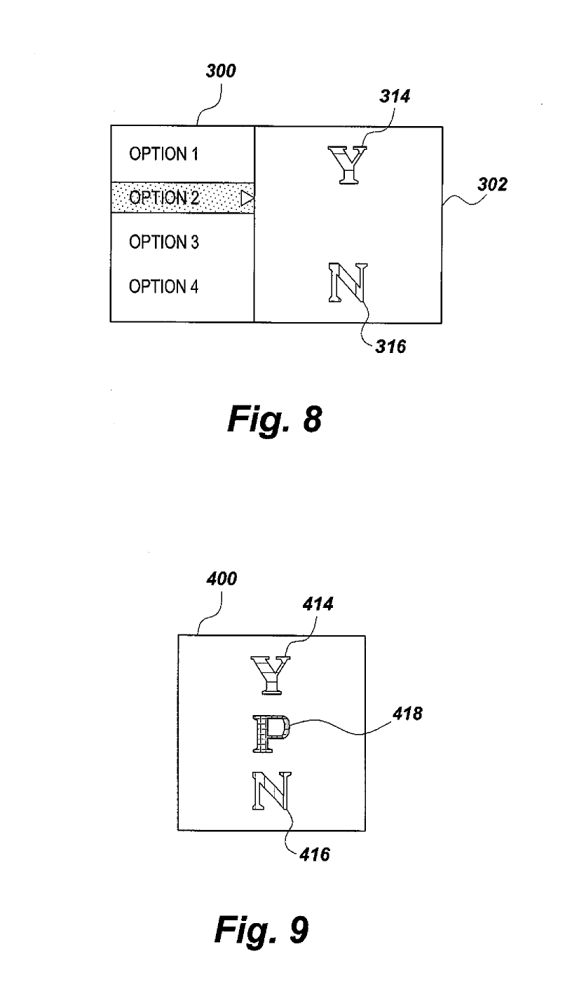

As a further embodiment, as shown in FIG. 8, the option box 302 (similar to option box 12 of FIG. 1, with options 314, 316) may be sized to have the same vertical height as the menu 300 (as opposed to the smaller option box 12 in FIG. 1). FIG. 9 illustrates a further alternative embodiment in which an additional choice is added to the “yes” or “no” options described above. In addition to a “Y” choice 414 and an “N” choice 416 (similar to “Y” 14a and “N” 16a of FIG. 1), the option box 400 includes a third “P” choice 418, which options a properties window, similar to a conventional properties window in the WINDOWS® operating system, for example, for displaying file or application properties. In FIG. 9, it should be understood that the exemplary “Y” and “N” may be replaced by any of the “accept” or “decline” options described above, or may be replaced by any similar “accept” or “decline” graphics, options or text, such as “Go” and “No Go”, for example.

Although described above with reference to mouse interface devices, touch pads and the like, it should be understood that the above embodiments may be implemented by any suitable type of user interface, such as laser pointers, light pens, touch screens or the like. It should be further understood that the present clickless graphical user interface for displaying and selecting a pop-up menu may be used independently as a single interface, or may be used in combination with one or more other forms of user interface, such as in combination with a conventional mouse click interface, for example. With particular respect to alternatives to navigation, in a first option, the user may move the cursor within a semi-circular base or on an arc line to point at any object within the desktop. As an alternative option, the mouse may be moved freely on the desktop towards the object and the mouse will point the circular head to the object remotely without traveling to the object location. A calculation of the distance between objects and the pointer location will be performed, the cursor will snap to the closest object border. The user will be able to move or reposition the pointer a little bit to point the pointer to a different object, similar to the usage of a flash light in a dimmed environment. As a third option, the user may use his finger with an attached light pointer freely and externally to any object on the desktop. Also, the user may choose to use a laser pen or light pen to navigate through objects externally. The system will not be affected by ambient light(s) since the pen or finger pointer will have a specific light intensity or wavelength to distinguish itself. When the user moves the cursor towards an object, a thin light will point to the object with the circular head and line light extending from the mouse location to the object. The user may choose to stop near the object or go over directly on the object to navigate. A default setting could be the pointer staying near the object by highlighting it and waiting for the user to move over the object to open/launch the object. When the user points the mouse to the object without traveling to the location of the object, laser or flash light-like thin line with circular head will point to the objects and the circular head will be near, first, and then on the object if the user moves it over the object. When the circular head nears the object, pointing arrows will point to the object and the object will be opened when the circular head is moved over the object. It should be note that the system will dim the desktop light slightly or sharpen the light intensity if needed.

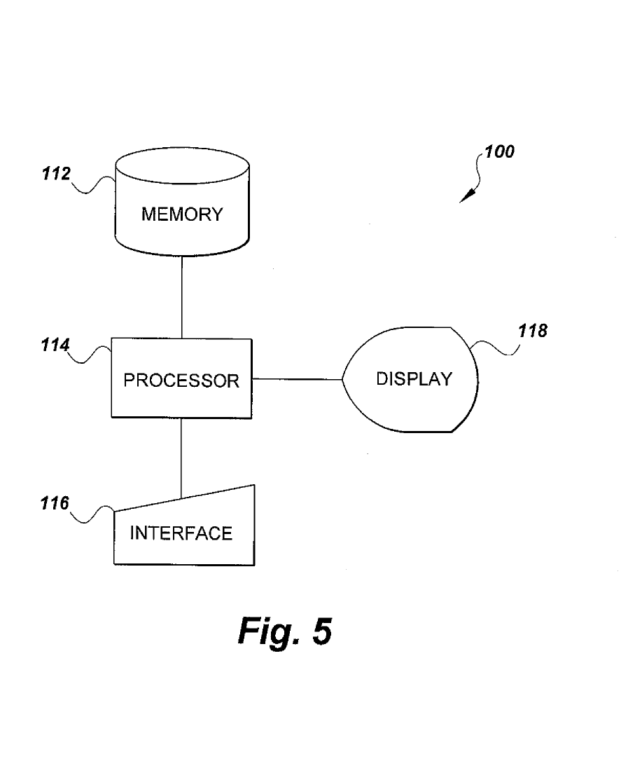

It should be understood that any calculations or computer operations may be performed by any suitable computer system, such as that diagrammatically shown in FIG. 5. Data is entered into system 100 via any suitable type of user interface 116, and may be stored in memory 112, which may be any suitable type of computer readable and programmable memory and is preferably a non-transitory, computer readable storage medium. Calculations are performed by processor 114, which may be any suitable type of computer processor and may be displayed to the user on display 118, which may be any suitable type of computer display. Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It is to be understood that the present invention is not limited to the embodiments described above, but encompasses any and all embodiments within the scope of the following claims.

We claim:

1. A computer-implemented clickless graphical user interface method for interfacing a user with a display device, the method comprising the steps of:
displaying a pop-up window when a cursor is moved over an object on the display device, wherein the object is selected from the group consisting of a file and an application;
displaying a plurality of menu item choices in the pop-up window, the choices representing a set of alternative execution-related computer actions related to the object, a display of properties associated with the object, and a cancellation choice; and
executing a specific one of the choices corresponding to cursor placement of the cursor over the specific one of the menu item choices solely in response to cursor position.

2. The computer-implemented clickless graphical user interface method according to claim 1, wherein said step of displaying a plurality of menu items comprises the step of displaying unique text representing each of the menu item choices presented to the user.

3. The computer-implemented clickless graphical user interface method according to claim 1, wherein said step of displaying a plurality of menu items comprises the step of displaying unique color schemes representing each of the menu item choices presented to the user.

4. The computer-implemented clickless graphical user interface method according to claim 1, wherein said step of displaying a plurality of menu items comprises the step of displaying unique iconic shape indicia representing each of the menu item choices presented to the user.

5. The computer-implemented clickless graphical user interface method according to claim 1, wherein said object is the title bar of a window.

6. The computer-implemented clickless graphical user interface method according to claim 1, further comprising the steps of:
displaying a sequence of related menus when the cursor is moved over the object; and
condensing the sequence of related menus except for a final one of the menus adjacent the pop-up window.

7. The computer-implemented clickless graphical user interface method according to claim 6, wherein the step of condensing the sequence of related menus except for the final one of the menus adjacent the pop-up window comprises displaying a stacked sequence of portions of the related menus.

8. The computer-implemented clickless graphical user interface method according to claim 1, further comprising the step of replacing the cursor with a directional indicator graphic adjacent the pop-up window when the cursor is moved within a pre-defined distance threshold of the pop-up window.

9. A computer software product, comprising a non-transitory computer storage medium readable by a processor, the non-transitory computer storage medium having stored thereon a set of instructions for establishing a clickless graphical user interface, the set of instructions including:
(a) a first sequence of instructions which, when executed by the processor, causes said processor to display a pop-up window when a cursor is placed over an object on the display device, wherein the object is selected from the group consisting of a file and an application;
(b) a second sequence of instructions which, when executed by the processor, causes said processor to display a plurality of choices in said pop-up window, the choices representing a set of alternate execution-related computer actions related to the object, a display of properties associated with the object, and a cancellation choice; and
(c) a third sequence of instructions which, when executed by the processor, causes said processor to execute a specific one of the choices corresponding to cursor placement of the cursor over the specific one of the menu item choices solely in response to cursor position.

10. The computer software product according to claim 9, wherein said second sequence of instructions further comprises displaying unique text representing each of the menu item choices presented to the user.

11. The computer software product according to claim 9, wherein said second sequence of instructions further comprises displaying unique color schemes representing each of the menu item choices presented to the user.

12. The computer software product according to claim 9, wherein said second sequence of instructions further comprises displaying unique iconic shape indicia representing each of the menu item choices presented to the user.

13. The computer software product according to claim 9, wherein said object is the title bar of a window.

14. The computer software product according to claim 9, wherein said first sequence of instructions further comprises:
(d) a fourth sequence of instructions which, when executed by the processor, causes the processor to display a sequence of related menus when the cursor is moved over the object; and
(e) a fifth sequence of instructions which, when executed by the processor, causes the processor to condense the sequence of related menus except for a final one of the menus adjacent the pop-up window.

15. The computer software product according to claim 14, wherein the fifth sequence of instructions comprises a sixth sequence of instructions which, when executed by the processor, causes the processor to display a stacked sequence of portions of the related menus.

16. The computer software product according to claim 9, further comprising a seventh sequence of instructions which, when executed by the processor, causes the processor to replace the cursor with a directional indicator graphic adjacent the pop-up window when the cursor is moved within a pre-defined distance threshold of the pop-up window.
